(19) United States
(12) Patent Application Publication
(10) Pub. No.: US 2012/0018022 A1
(43) Pub. Date: Jan. 26, 2012

(54) Universal guide cover for a plumber's drain cleaning cable

(76) Inventors: Verlan Hubert Davis, Ventura, CA (US); John Joseph Davis, Ellenton, FL (US); Patrick Joseph Dain, Ventura, CA (US)

(21) Appl. No.: 12/930,509

(22) Filed: Jan. 29, 2010

(51) Int. Cl. F16L 11/00

(52) U.S. Cl. 138/109

(57) ABSTRACT

Universal Guide Cover for a plumber's drain cleaning cable consists of a flexible hose type device to which is affixed a coupling on each end. The Universal Guide Cover is free floating and can be moved upon a plumber's drain cleaning cable as needed. The couplings on the ends of the Universal Guide Cover allow the user to join multiple Universal Guide Covers together as needed. Universal Guide Covers are utilized to protect the work area from the actions of a plumber's drain cleaning cable. Operation of a plumber's drain cleaning cable is made safer and easier to use with a Universal Guide Cover. A Universal Guide Cover for a plumber's drain cleaning cable is designed to be used with any size drain cleaning cable.

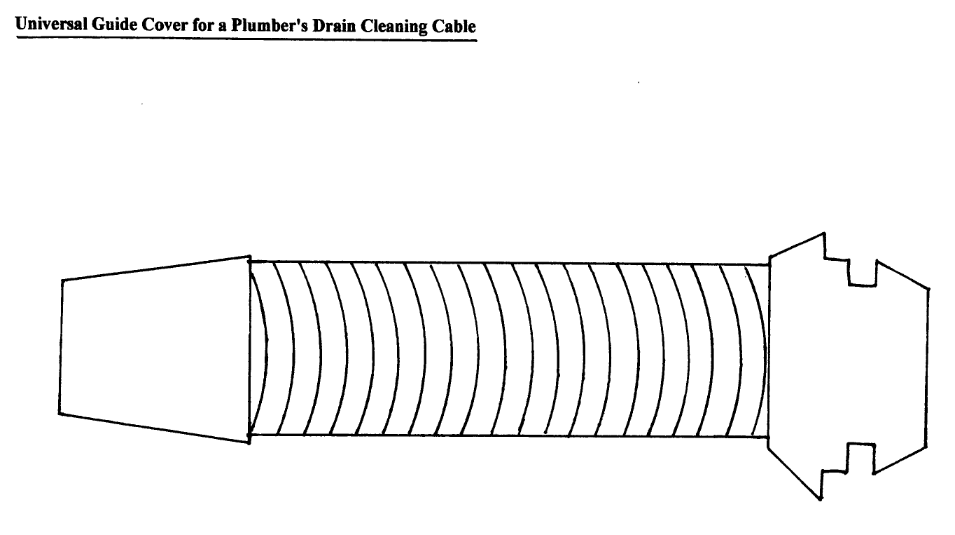

### U.S. PATENT DOCUMENTS SEARCHED

| | | |
|---|---|---|
| 608418 | August 1898 | Bradley |
| 1,132,691 | March 1915 | Sieben |
| 1,181,616 | May 1916 | Sandblom |
| 1,261,444 | April 1918 | Schied |
| 1,549,761 | August 1925 | Fuchs et al. |
| 1,796,340 | March 1931 | Nowakowski |
| 1,851,766 | March 1932 | Hotchkiss, Jr. |
| 1,982,402 | November 1934 | Shade |
| 2,042,407 | May 1936 | Kugelman |
| 2,175,406 | October 1939 | Osborn |
| 2,181,306 | November 1939 | Osborn |
| 2,468,490 | April 1949 | DiJoseph |
| 2,730,740 | January 1956 | O'Brien |
| 2,838,779 | June 1958 | Brydges et al. |
| 2,961,675 | November 1960 | Stickney |
| 3,007,186 | November 1961 | Olsson |
| 3,093,854 | June 1963 | Silverman |
| 3,095,592 | July 1963 | Hunt |
| 3,118,159 | January 1964 | Kollmann |
| 3,121,244 | February 1964 | Hunt |
| 3,134,119 | May 1964 | Criscuolo |
| 3,246,354 | April 1966 | Cooney et al. |
| 3,394,599 | July 1968 | Tucker |
| 3,449,783 | June 1969 | Kirschke |
| 3,605,158 | September 1971 | Russell |
| 3,740,785 | June 1973 | Latall |
| 3,747,153 | July 1973 | O'Neill |
| 3,883,150 | May 1975 | Varela |
| 4,364,140 | May 1981 | Irwin |
| 4,364,139 | December 1982 | Babb et al. |
| 4,516,286 | May 1985 | Crane |
| 4,580,306 | April 1986 | Irwin |
| D287654 | January 1987 | Boelens |
| 4,766,631 | August 1988 | Crane et al. |
| 4,914,775 | April 1990 | Kirk |
| 5,379,476 | January 1995 | Salecker |
| 5,682,620 | November 1997 | Soltz |
| 7,168,451 | January 2007 | Dandas |

### FIELD OF THE INVENTION

The present Invention is in the field of tools; more particularly accessories for plumbing.

### BACKGROUND OF THE INVENTION

There is a need for a Universal Guide Cover for a plumber's drain cleaning cable. Guide Covers help contain the rotating motion of plumber's drain cleaning cable which can cause damage to adjacent items in the work area. There is a need for a plumber to be able to have the option of joining multiple Universal Guide Covers together as needed. There is a need for a Universal Guide Cover that will fit various size plumber's drain cleaning cables, and, there is a need for a Universal Guide Cover that can be positioned over a particular section of a plumber's drain cleaning cable as needed on the worksite. Drain cleaning cable machines that do not have a drum to enclose their drain cleaning cable would greatly benefit from a Universal Guide Cover.

### DISCUSSION OF KNOWN ART

No known art for a Universal Guide Cover for a plumber's drain cleaning cable is known. Several drain cleaning cable machine manufacturers possess a drum that encloses the drain cleaning cable. Some of these machines employ a fixed, non-universal guide cover as an attached integral part of their machine. These machines do not need a Universal Guide Cover as their non universal guide cover serves it's own purpose of limiting rotational spin and spillage. Their covers are fixed, non-universal, and for use only with their respective machines.

### OBJECTS OF THE INVENTION

It is an object of this invention to provide a Universal Guide Cover which will fit any diameter plumber's drain cleaning cable.

It is an object of this invention to provide a means whereby multiple guide covers may be attached to one another.

It is an object of this invention to provide a means where a universal guide cover may be easily moved from one location to another upon a plumber's drain cleaning cable.

It is an object of this invention to provide a means of reducing excess rotational spin of the a plumber's drain cleaning cable from damaging the work area.

It is an object of this invention to prevent spillage when the plumbers drain cleaning cable is removed from the drain.

### BRIEF DESCRIPTION OF THE DRAWING

The attached drawing is a horizontal view of the Universal Guide Cover and shows the flexible hose body in the center, a female adaptor on the left side and a male adaptor on the right side.

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description, and all variations, substitutions and changes which come within the meaning and range of equivalency of the claims are therefore intended to be embraced therein.

### REMARKS

This substitute specification contains no new matter to the invention. The Replacement Sheet drawing is a clearer copy than the original drawing and shows the invention in a more horizontal position.

What is claimed is:

1. A flexible hose type device of varying length to which is affixed a coupling on each end. The couplings can be either threaded or pressure fit style.

2. Multiple Universal Guide Covers may be joined together by use of the coupling adapters present on each cover to an indefinite length.

3. The Universal Guide Cover is free floating and can be moved freely over a plumber's drain cleaning cable as needed.

4. The Universal Guide Cover can be of any diameter to fit any plumber's drain cleaning cable.
